(19) United States
(12) Patent Application Publication
(10) Pub. No.: US 2005/0235290 A1
(43) Pub. Date: Oct. 20, 2005

(54) Computing system and method for transparent, distributed communication between computing devices

(76) Inventors: Stanley T. Jefferson, Palo Alto, CA (US); Randy A. Coverstone, Newark, CA (US); Steven Greenbaum, Palo Alto, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/828,141

(22) Filed: Apr. 20, 2004

(51) Int. Cl. G06F 9/46

(52) U.S. Cl. 719/310

(57) ABSTRACT

A distributed computing system and method is provided for executing block diagram software applications across multiple computing devices. A first computing device is configured to execute a first block of a block diagram software application to produce an output. The first computing device transparently communicates with a second computing device to provide the output of the first block to a second block of the block diagram software application resident on the second computing device.

### BACKGROUND OF THE INVENTION

In recent years, software applications have advanced from monolithic, self-contained applications to component applications that can be easily built from a series of pre-existing software modules, called components, each providing a different function. One example of a component application is a block diagram software application that consists of blocks, interconnected by lines. The blocks represent actions that take zero or more inputs and produce zero or more outputs. The lines represent connections of block inputs to block outputs. Outputs can be produced at arbitrary points in time or at specific points in time.

One type of block diagram software application is a simulation software application, such as Simulink, which is a software package sold by The MathWorks for simulating dynamical systems. Simulink includes a large library of blocks, called S-functions, from which a user can select to construct a simulation. In addition, a user can create new blocks that can be used in the same way as the prebuilt blocks. Simulations created using Simulink can be targeted to execute on a wide range of computing devices, including embedded and real-time hardware. A simulation or part of a simulation can serve as an implementation (of a software program, hardware firmware, hardware circuit, etc.) when the simulation is targeted to a device that achieves the performance requirements of an implementation. Another similar type of simulation software application is SystemBuild, which is a software package sold by National Instruments and is a part of the MATRIXx product suite.

At the same time that software applications advanced from monolithic to component applications, computing environments advanced from monolithic, stand-alone computing environments, where all applications are executed on a single computing platform, to distributed computing environments, where applications can be cooperatively executed on multiple computing devices. For many block diagram software applications, such as simulation software applications, computing time can be reduced and more accurate results can be obtained by executing different blocks of a block diagram software application across multiple computing devices. For example, although a test and measurement system can be executed in Simulink on a monolithic computing environment, physical considerations may require that a part of the Simulink software application reside within measurement hardware, and another part of the Simulink software application reside within a computing device capable of sophisticated data processing and graphical user interfaces.

However, there have been some inefficiencies in traditional distributed computing environments when applied to block diagram software applications. One example of a traditional distributed computing environment is the client-server model. Typically, a server includes a master software program that is responsible for accepting new requests from clients and a set of slave software programs that are responsible for handling individual requests. A new slave program is created for each new request received by the master program, and processing can proceed concurrently between the slave programs.

Although the current client-server model is an effective tool for interacting between software applications distributed across multiple computing devices, certain aspects of the client-server model have proven to be inadequate if applied to the interaction between different blocks of the same block diagram software application distributed across multiple computing devices. For example, starting a new slave program for each new request between blocks of the same block diagram software application is an inefficient usage of resources at the server. In addition, each time a client or server is replaced, an identification and authentication procedure takes place between the client and the server before processing can continue.

Another example of a traditional distributed computing environment is the peer-to-peer model. In the peer-to-peer model, a software application resident on one computing device publishes a request to other software applications resident on other computing devices. The request is handled by the first software application that responds to the request. However, peer-to-peer models do not allow for direct communication between two computing devices. Furthermore, there is no data flow control in peer-to-peer models to prevent data loss between the computing devices.

### SUMMARY OF THE INVENTION

Embodiments in accordance with the invention provide a distributed computing system and method for executing block diagram software applications across multiple computing devices. A first computing device is configured to execute a first block of a block diagram software application to produce an output. The first computing device transparently communicates with a second computing device to provide the output of the first block to a second block of the block diagram software application resident on the second computing device.

In one embodiment, the communication devices transparently communicate by a communications protocol that uses a channel Application Programming Interface (API). The channel API provides a channel connection that dynamically links two blocks of a block diagram software application, each being executable on separate computing devices. The channel connection serves to identify and utilize a queue channel corresponding to a connection between the two blocks.

In one implementation embodiment, the queue channel identifies the address of a queue within a computing device. Data output from a first block running on a first computing device is transmitted to a second computing device and queued into the queue channel on the second computing device. The queued data is read out of the queue channel and utilized during execution of a second block of the block diagram software application on the second computing device.

In further implementation embodiments, a single slave thread is used to receive and queue all of the data output from the first block of the block diagram software application and transmitted from the first computing device. In other implementation embodiments, the channel connection manages and controls the flow of data between the first and second blocks on the first and second computing devices.

Advantageously, the channel connection enables transparent execution of a block diagram software application distributed across multiple computing devices, thereby reducing processing time and improving accuracy. In addition, using a single slave thread to receive and queue all data from a remote computing device provides an efficient usage of resources. Moreover, providing a data flow control mechanism prevents data loss and maintains the execution order of the software. Furthermore, the invention provides embodiments with other features and advantages in addition to or in lieu of those discussed above. Many of these features and advantages are apparent from the description below with reference to the following drawings.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 depicts one example of a distributed computing environment in which the present invention can operate;

FIG. 2 depicts another example of a distributed computing environment in which the present invention can operate;

FIG. 3 is a block diagram illustrating an exemplary computing device on which the present invention can operate;

FIGS. 4A and 4B are functional block diagrams illustrating an embodiment of the present invention;

FIGS. 5A-5E illustrate exemplary functionality for using a channel connection to execute a block diagram software application across two computing devices, in accordance with embodiments of the present invention;

FIG. 6 illustrates exemplary functionality for executing block diagram software applications across multiple computing devices, in accordance with embodiments of the present invention;

FIG. 7A illustrates exemplary functionality of a channel connection of the block diagram software application at the sending computing device, in accordance with embodiments of the present invention;

FIG. 7B illustrates exemplary functionality of a channel connection of the block diagram software application at the receiving computing device, in accordance with embodiments of the present invention;

FIG. 8 illustrates exemplary functionality of the channel for providing data control flow between the sending and receiving computing devices, in accordance with embodiments of the present invention;

FIGS. 9A-9C are flow charts illustrating an exemplary process for executing a channel connection via a FROM block at a receiving computing device, in accordance with embodiments of the present invention;

FIGS. 10A-10C are flow charts illustrating an exemplary process for executing the channel connection via a TO block at a sending computing device, in accordance with embodiments of the present invention;

FIG. 11A is a flow chart illustrating an exemplary process for executing an initialize network routing of the channel connection, in accordance with embodiments of the present invention;

FIG. 11B is a flow chart illustrating an exemplary process for executing a terminate network routine of the channel connection, in accordance with embodiments of the present invention; and

FIG. 12 is a flow chart illustrating a simplified exemplary process for executing a Simulink simulation on a single device.

### DETAILED DESCRIPTION OF THE EXEMPLARY EMBODIMENTS

The numerous innovative teachings of the present application will be described with particular reference to the exemplary embodiments. However, it should be understood that these embodiments provide only a few examples of the many advantageous uses of the innovative teachings herein. In general, statements made in the specification do not necessarily delimit any of the various claimed inventions. Moreover, some statements may apply to some inventive features, but not to others.

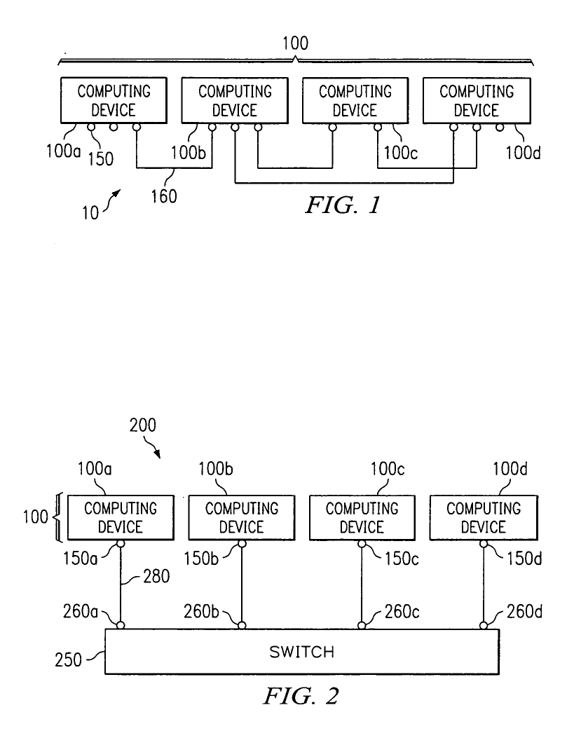

The present invention can be operated on any type of distributed computing environment, including, but not limited to a bi-directional computing environment, a shared medium computing environment (e.g., USB) or a networked computing environment. FIGS. 1 and 2 illustrate examples of bi-directional and networked distributed computing environments, respectively. Each distributed computing environment has multiple interconnected computing devices 100. The computing devices 100 include any device capable of running at least a portion of a block diagram software application. By way of example, but not limitation, the computing devices 100 can be personal computers, mainframe computers, minicomputers, network servers, web servers, routers, switches or embedded computers built into another device or system, such as a video game player, microwave oven, measurement instrument, etc.

In the bi-directional distributed computing environment 10 shown in FIG. 1, each computing device 100a-d contains multiple ports 150 that provide cable interfaces to transceivers within the computing devices 100a-d. Cables 160 interconnect the port 150 of one computing device, e.g., computing device 100a, to the port 150 of another computing device, e.g., computing device 100b, to provide bi-directional communication between the transceivers of the two computing devices 100a and 100b. The cables 160 can be coaxial cables, twisted pair wires, optical fibers, wireless (air) interfaces or any combination or modification thereof. Communication between the computing devices 100a-d can be based on any communication protocol using a bi-directional transport mechanism, such as the IEEE 1394 Serial Bus (FireWire).

In the networked distributed computing environment 200 of FIG. 2, the computing devices 100a-d are interconnected via a switch or hub 250. Each computing device 100a-d contains a port 150a-d that provides a cable interface to a transceiver within the computing devices 100a-d. A cable 280, such as a coaxial cable, twisted pair wire, optical fiber, air interface or any combination or modification thereof, connects between the port, e.g., port 150a of computing device 100a, and a respective port 260a on the switch 250. The ports 260a-d on the switch 250 are connected to a switching fabric within the switch 250. For example, the switching fabric can be a high-speed bus, a crossbar, a multistage switching array or other type of switching mechanism.

Communications between computing devices 100a-d can be based on any data transport protocol, such as the Transmission Control Protocol (TCP)/Internet Protocol (IP), using any type of network transport mechanism. Examples of network transport mechanisms include Ethernet, frame relay, Switched Multimegabit Data Service (SMDS), Asynchronous Transfer Mode (ATM), Synchronous Optical Network (SONET)/Synchronous Digital Hierarchy (SDH). In other embodiments, communications between computing devices 100a-d can be based on a short range wireless protocol, such as Bluetooth, or other mobile/wireless protocol, such as Code Division Multiple Access (CDMA), Digital Advanced Mobile Phone Systems (D-AMPS), Global System for Mobile Communications (GSM), Digital European Cordless Telecommunications (DECT) or Cellular Digital Data Packet (CDPD).

For example, communications can be sent in frames or packets (hereinafter frames), using destination addresses to identify the intended recipient of a particular frame. The destination address of a frame received at one port 260a of the switch 250 from an originating computing device 100a is examined by the switching fabric within the switch 250 to route the frame to the port 260d on the switch 250 associated with the receiving computing device 100d. In this way, communications are routed between computing devices 100a-d within the distributed network computing environment 200. It should be understood that the distributed network computing environment 200 can be extended to include multiple switches 250, each connected (via a cable or air interface) to one or more computing devices 100, to interconnect a number of computing devices 100 across any geographical area.

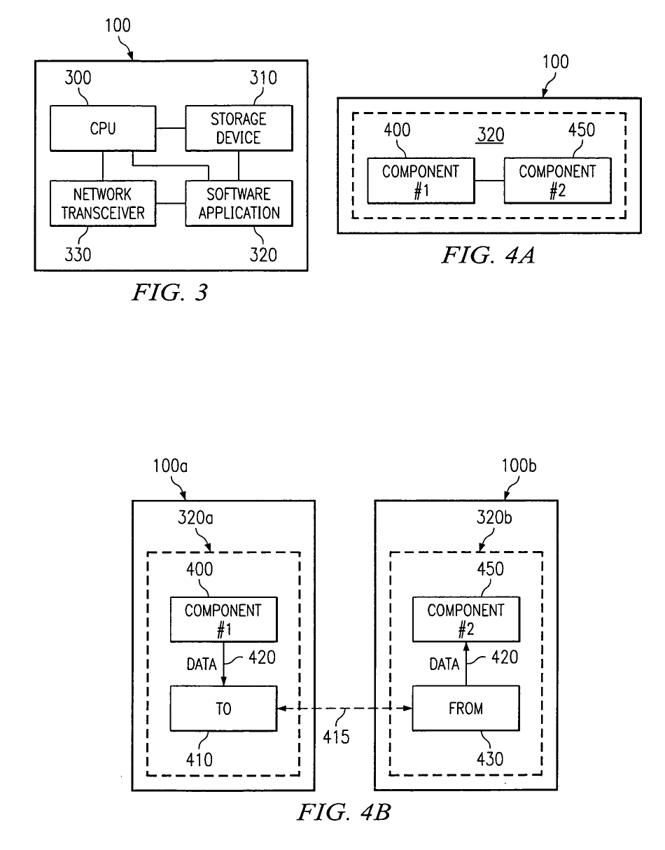

As shown in FIG. 3, each of the computing devices 100 includes various hardware, software and middleware. For example, the computing device 100 can include a central processing unit (CPU) 300, such as a microprocessor, microcontroller or other processing device, a network transceiver 330 and/or network card for connecting the computing device 100 to other computing devices, and one or more storage devices 310, such as a ZIP® drive, floppy disk, hard drive, CD-ROM, non-volatile memory device, tape, database or any other type of storage medium. The computing device 100 can further include one or more block diagram software applications 320 that can be stored on one or more of the storage devices 310 and run using the CPU 300, network transceiver 330 and storage device 310. Each block diagram software application 320 is formed of pre-built and user-defined software modules, called blocks, interconnected by lines. Each block is formed of computer-executable instructions which, when read and executed by the CPU 300, causes the computing device to perform the steps necessary to execute the block. Thus, the blocks represent actions that take zero or more inputs and produce zero or more outputs, and the lines represent connections of block inputs to block outputs. It should be understood that outputs can be produced at arbitrary points in time or at specific points in time. One or more of the blocks of a particular block diagram software application 320 are included within the block diagram software application 320 stored on the computing device 100. Other blocks of the particular block diagram software application 320 can be stored on other computing devices.

For example, as shown in FIGS. 4A and 4B, a block diagram software application 320 having a first block 400 and a second block 450 can be split between two computing devices 100a and 100b, such that the first block 400 is included on a block diagram software application 320a stored on the first computing device 100a, and the second block 450 is included on a block diagram software application 320b stored on the second computing device 100b. At the application level, a channel connection 415 is introduced that logically connects the first block 400 on the first computing device 100a (hereinafter the sending computing device 100a) to the second block 450 on the second computing device 100b (hereinafter the receiving computing device 100b). The channel connection 415 includes a TO block 410 on the sending computing device 100a and a FROM block 430 on the receiving computing device 100b. The TO and FROM blocks 410 and 430 run using middleware that provides transparent, distributed communication between the computing devices 100a and 100b. Thus, data 420 output from the first block 400 is transparently provided to the second block 450 via the channel connection 415.

Together, the block diagram software applications 320a and 320b on the two computing devices 100a and 100b, respectively, shown in FIG. 4B, implement the same functionality as the block diagram software application 320 on the single computing device 100 shown in FIG. 4A. However, by partitioning the original block diagram software application 320 into blocks, the blocks can be used separately in a variety of different settings. For example, the output data 420 of the first block 400 could be read by a new and different block diagram software application (not shown). It should be understood that computing devices 100a and 100b operate asynchronously and wait for the other device 100a or 100b to respond. In addition, it should be understood that the TO and FROM blocks 410 and 430 communicate via the channel mechanism 415, while other blocks on the same computing device communicate with each other via internal memory of the device on which they are executed.

The channel connection 415 uses a channel protocol to enable a natural and flexible communication mechanism between computing devices 100a and 100b and block diagram software applications. The underlying channel protocol of the channel connection 415 provides data flow control and maintains the proper execution order of the original uncut block diagram software application in order to prevent data loss and deadlock situations from arising. In addition, the channel protocol can be adapted to multi-rate systems, where data is sent at different sample rates from different sending blocks. The channel protocol can be specified in any software, hardware or firmware specification language, such as the C++ programming language, and can be implemented as a Dynamic Link Library (DLL).

As an example, an Application Programming Interface (API) for the channel protocol can be as follows:

```
Parameters
  status (output): status code from above list.
Remarks
  Starts a channel server.
Extern
void APIENTRY ChannelServerStart (long *status);
Remarks
  Stops the channel server started by the calling process.
Extern
void APIENTRY ChannelServerStop ( );
Parameters
  serverName (input): a numeric or symbolic IP address. The IP address of the server
to connect with.
  socket (output): socket for the client connection.
  timeout (input): timeout in milliseconds for establishing a connection.
  status (output): status code from above list.
Remarks
  Attempts to establish a connection with the specified server. If established, the client
socket is returned.
Extern
void APIENTRY ChannelClientStart (const char *serverName, SOCKET *socket DWORD
timeout, long *status);
Parameters
  client (input): socket which is to be closed.
Remarks
  Closes the specified client connection.
Extern
void APIENTRY ChannelClientStop (SOCKET client);
Parameters
  channelNumber (input): channel to read from.
  data (output): buffer to receive data.
  size (input/output): input value is the maximum number of bytes DATA buffer can
contain. Output value is the size of the data that was transmitted to the channel. If the
maximum is exceeded BUFFERSIZE_ERR status is left unchanged.
  timeout (input): timeout in milliseconds.
  status (output): status code from above list.
Remarks
  Reads a datablock from the specified channel of the server running under the calling
process.
Extern
void APIENTRY ChannelRead (long channelNumber, BYTE *data, long *size, DWORD
timeout, long*status)
Parameters
  client (input): client connection to use for write.
  channelNumber (input): channelNumber to use for write.
  data (input): data to be written.
  size (input): number of bytes of data to write.
  timeout (input): timeout in milliseconds.
  status (output): status code from above list.
Remarks
  Write data to the specified channel of the server connected to the specified client
socket.
Extern
void APIENTRY ChannelWrite (SOCKET client, long channelNumber, BYTE *data, long
size, DWORD timeout, long *status);
```

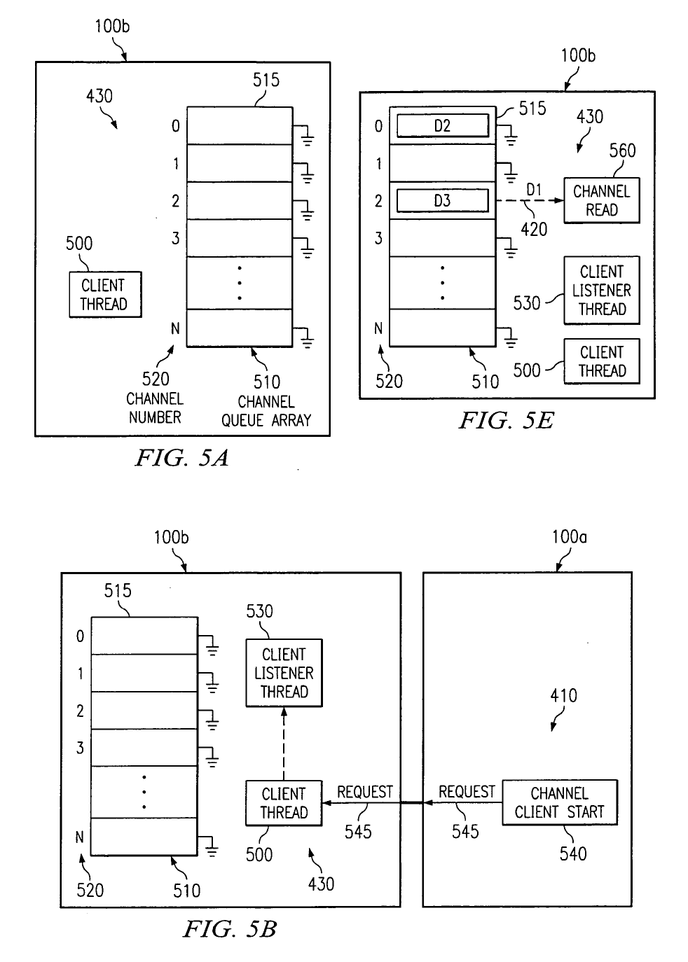

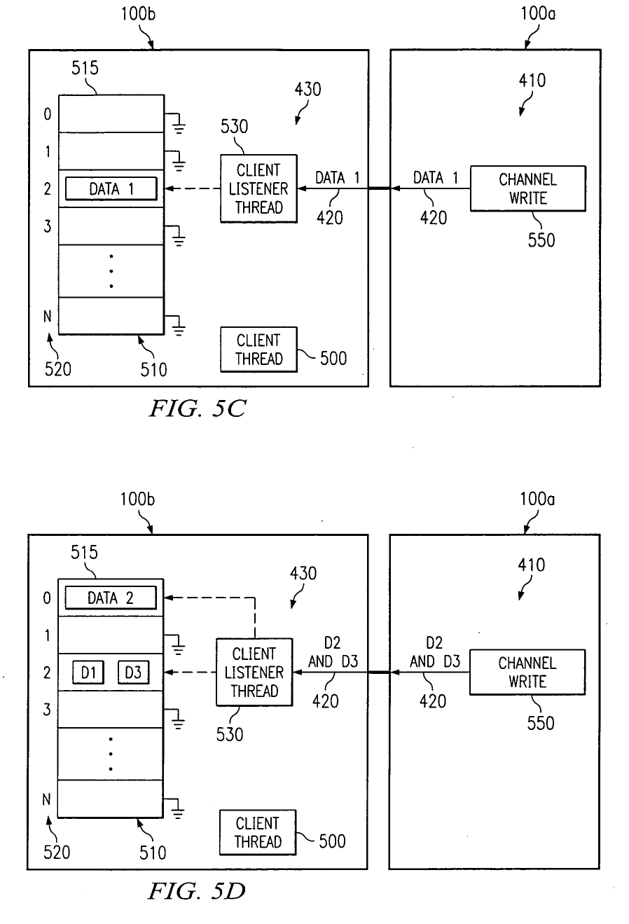

Referring now to FIGS. 5A-5E, an exemplary TCP/IP implementation of the channel protocol is illustrated. However, it should be understood that the channel protocol can be applied to other implementations as well, and is not limited to the following TCP/IP implementation.

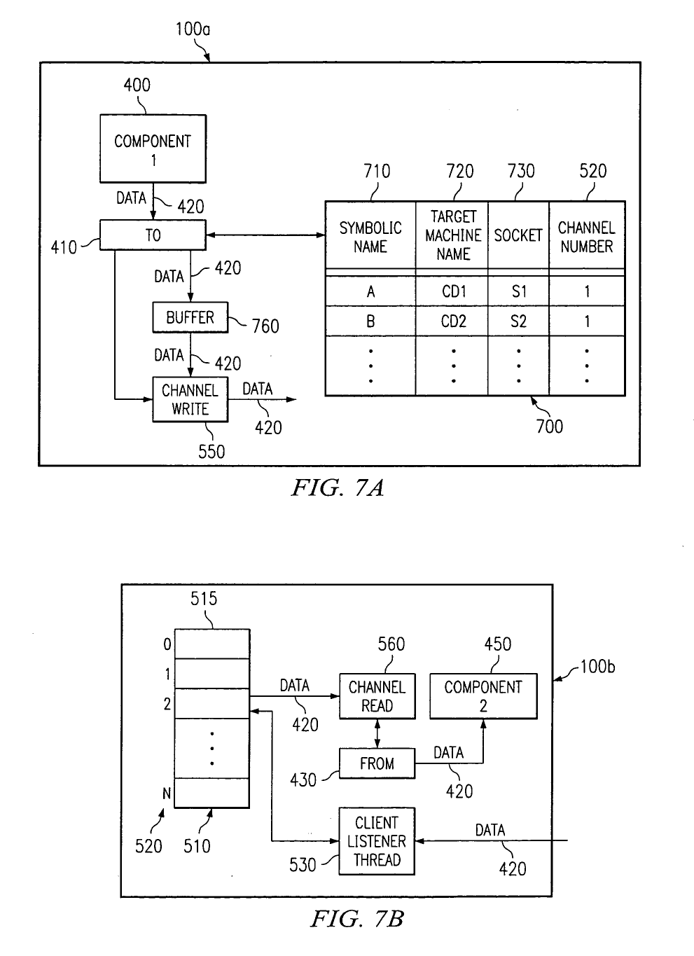

The underlying communication mechanism of the channel protocol for TCP/IP is a queue channel 515. Generally, one or more queue channels 515 correspond to a connection between two blocks of a block diagram software application running on different computers. The queue channels are identified by dynamically linking between a block identifier specified by the software block resident on the sending computing device 100a and a channel identifier, as described in more detail below in connection with FIGS. 7A and 7B. In the implementation shown in FIG. 5A, a queue channel 515 corresponds to the address of a queue within a channel queue array 510 that receives and enqueues data blocks. Data blocks are contiguous blocks of unsigned long memory. Any type of data may be present in the data block. For example, to transmit an array of floating point numbers, the data block can include a pointer to the data, appropriately coerced, and the size of the data. The size of a data block can vary each time a data block is sent. The maximum size of a data block is arbitrary and can be set when a process initializes the channel connection. A larger maximum data block size increases the memory required for each channel 515.

A queue channel 515 is addressed by dynamically linking to a node identity (or target computing device name) and a channel number 520. The maximum channel number 520 is an arbitrary implementation decision. For example, in one embodiment, channel numbers 520 can range from 0 to 63. In another embodiment, channel numbers 520 can range from 0 to 255. A receive queue associated with a queue channel 515 can store one or more data blocks. Distributed, multi-rate systems can be implemented by appropriately adjusting the queue size of the receive queues.

FIG. 5A illustrates the initialization of the channel protocol associated with the FROM block 430 at the receiving computing device 100b. A fixed number of queue channels 515 within the channel queue array 510 are allocated to a particular block diagram software application when the channel protocol is initialized. The allocated channel numbers 520 are provided to the sending computing device to send data blocks associated with the block diagram software application to the receiving computing device 100b. A client thread 500 is initialized at the receiving computing device 100b to wait for a service request from a client (i.e., sending computing device). The channel protocol at the receiving computing device 100b can run out of a fixed port or multiple ports on the receiving computing device 100b.

At the sending computing device 100a, as shown in FIG. 5B, the channel protocol associated with the TO block 410 is initialized using a Channel Client Start routine 540 that sends a service request 545 to the receiving computing device 100b and obtains a socket (connection) from the receiving computing device 100b for subsequent communication between the sending and receiving computing devices 100a and 100b. A separate socket can be used for each queue channel 515, or a single socket can be used for multiple queue channels 515. Upon receipt of the service request 545, the client thread 500 creates a slave client listener thread 530 to handle the service request 545. The service request 545 identifies the queue channel(s) 515 allocated to the particular block diagram software application being run. A separate slave client listener thread 530 can be used for each new service request 545, in order to concurrently handle multiple service requests 545 from one or more computing devices 100a.

Referring now to FIG. 5C, a Channel Write routine 550 at the sending computing device 100a receives data 420 from the block diagram software application running on the sending computing device 100a and uses the socket obtained in FIG. 5B to send the data 420 (DATA 1) to a specified queue channel 515 (Channel 2) of the channel queue array 510 associated with the running block diagram software application on the receiving computing device 100b. The client listener thread 530 at the receiving computing device 100b receives the data 420 (DATA 1) and enqueues the data 420 on the specified queue channel 515 (Channel 2) of the channel queue array 510. The client listener thread 530 remains open until all data 420 associated with the block diagram software application is received. For example, FIG. 5D illustrates two more successive Channel Write operations (D2 and D3) handled by the client listener thread 530. Both are performed using the same socket obtained in FIG. 5B to enqueue data 420 (D2 and D3) on specified queue channels 515 (Channels 0 and 2) associated with the running block diagram software application. Each packet of a data block 420 is acknowledged and packets are resent until a complete data block 420 is received.

Referring now to FIG. 5E, a Channel Read routine 560 at the receiving computing device 100b dequeues the data 420 and returns the data 420 to the block diagram software application running on the receiving computing device 100b. The Channel Read routine 560 can be run simultaneous to the Channel Write routine (550, shown in FIG. 5D) to read out data 420 from one channel while it is being written to a different channel. The Channel Read routine 560 is initiated (e.g., by a FROM block in the exemplary embodiment of a Simulink block diagram software application) each time a block at the receiving computing device 100b requires further data from a connected channel.

It should be understood that in some embodiments, the data blocks 420 are not sent in a single batch, but rather the data blocks 420 are sent periodically. For example, the data 420 can be sampled and processed at the sending computing device 100a at time t₁, and at time t₂, the processed data can be sent in data blocks 420 to the receiving computing device 100b, while new data is sampled and processed at the sending computing device 100a. In addition, it should be understood that the software application blocks can have multiple inputs and multiple outputs connected to multiple software application blocks on one or more computing devices. Furthermore, it should be understood that in some embodiments, circular data paths between software application blocks are possible.

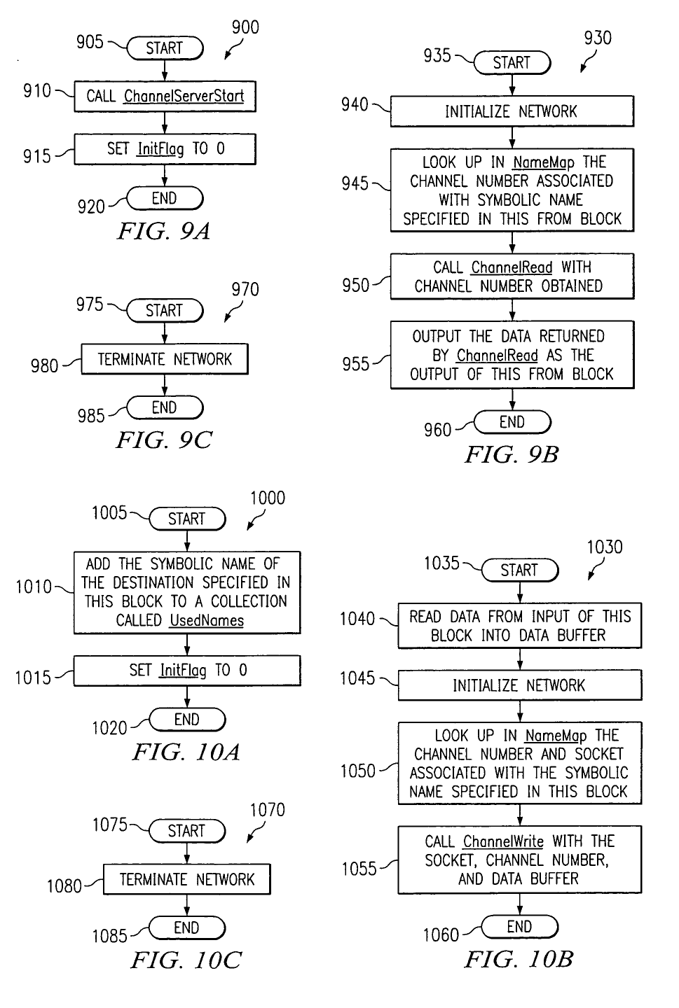

Exemplary processes for executing a channel connection of a block diagram software application as exemplified in Simulink documentation are shown in FIGS. 9-11. When a Simulink model is run, an initialization phase occurs where “mdlStart” routines of all blocks are run once, followed by a later run phase where “mdlOutput” routines are run. The mdlOutput routines are run once for each evaluation of the corresponding Simulink block to produce block outputs. At the end is a termination phase where “mdlTerminate” routines are run.

FIGS. 9A-9C illustrate an exemplary process for executing the channel connection via a FROM block at the receiving computing device. FIG. 9A shows the initialization phase 900 (mdlStart routine) of the FROM block under Simulink. The initialization phase starts at block 905. At block 910, a Channel Server Start routine is called to start a channel server for the FROM block. The Channel Server Start routine recognizes if a server has already been started for the associated device and returns without performing any action. At block 915, an initialization flag (InitFlag) is set to zero to initialize the channel. The initialization phase ends at block 920.

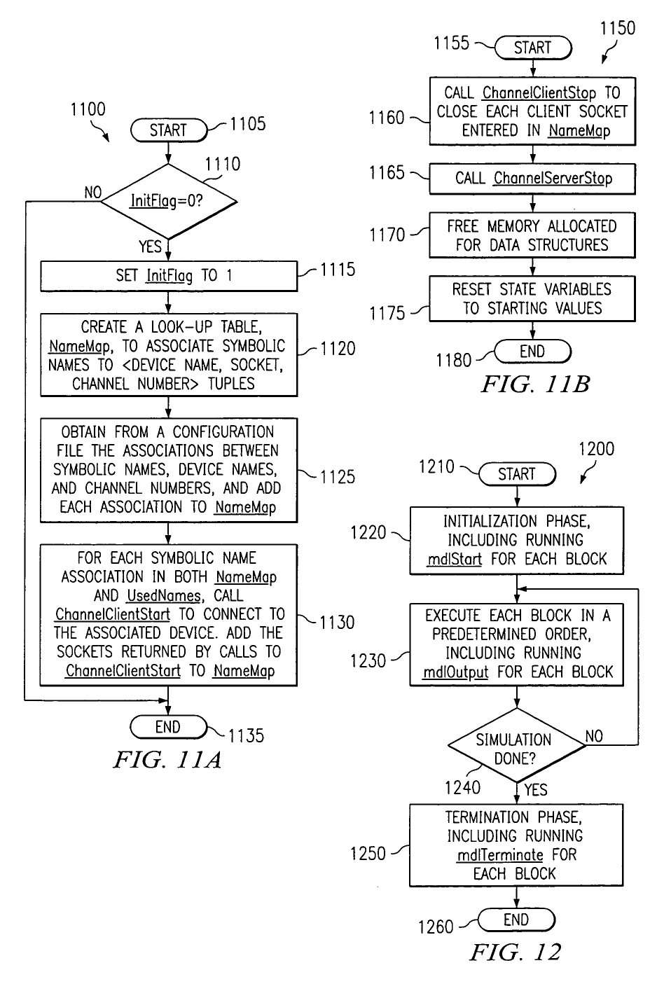

FIG. 9B shows the run phase 930 (mdlOutput) routine of the FROM block under Simulink. The run phase starts at block 935. At block 940, an initialize network routine is run. The initialize network routine 1100 is shown in FIG. 11. The initialize network routine starts at block 1105. At block 1110, a determination is made whether the initialization flag is set to zero. If the initialization flag is not set to zero, the process ends at block 1135. However, if the initialization flag is set to zero, at block 1115, the initialization flag is set to one, and a look-up table 700 in FIG. 7A, “NameMap,” is created to associate symbolic names to tuples, such as the device name, socket and channel number at block 1120. At block 1125, the associations between symbolic names and device names and channel numbers is obtained from a configuration file and added to NameMap. The configuration file contains a list of symbolic names associated with registered network targets (e.g., TO blocks on other computing devices). At block 1130, the Channel Client Start routine is called for each symbolic name association in NameMap to connect to the associated device. In addition, each socket returned by calls to the Channel Client Start routine is added to NameMap. The initialize network routine ends at block 1135.

Referring again to FIG. 9B, after the initialize network routine is run, at block 945, NameMap is accessed to look-up the channel number associated with the symbolic name specified in the FROM block. At block 950, the Channel Read routine is called with the obtained channel number. At block 955, the data returned by the Channel Read routine is output as the output of the FROM block. The run phase ends at block 960.

FIG. 9C shows the termination phase 970 (mdlTerminate) routine of the FROM block under Simulink. The termination phase starts at block 975. At block 980, a terminate network routine is run, and the termination phase ends at block 985. The terminate network routine 1150 is shown in FIG. 11B. The terminate network routine starts at block 1155. At block 1160, the Channel Client Stop routine is called to close each client socket entered in NameMap. At block 1165, the Channel Server Stop routine is called to close the channel server for the FROM block. At block 1170, the memory allocated for data structures (e.g., NameMap) for the FROM block is freed, and at block 1175, state variables (e.g., initialization flag) for the FROM block are reset to their starting values. It is assumed that redundantly performing an operation such as the Channel Server Stop routine or freeing allocated memory is ignored and does not result in an error (this can be accomplished with state variables or other means to keep track of what operations have already been performed and would be redundant). The terminate network routine ends at block 1180.

FIGS. 10A-10C illustrate an exemplary process for executing the channel connection for a TO block at the sending computing device. FIG. 10A shows the initialization phase 1000 (mdlStart routine) of the TO block under Simulink. The initialization phase starts at block 1005. At block 1010, the symbolic name of the destination (FROM block) specified in the TO block is added to a collection called UsedNames. At block 1015, an initialization flag (InitFlag) is set to zero to initialize the channel. The initialization phase ends at block 1020.

FIG. 10B shows the run phase 1030 (mdlOutput) routine of the TO block under Simulink. The run phase starts at block 1035. At block 1040, data from the input of the TO block is read an input into a data buffer. At block 1045, the initialize network routine 1100 shown in FIG. 11A and described above in connection with FIG. 9B is run. After the initialize network routine is run, at block 1050, NameMap is accessed to look-up the channel number and socket associated with the symbolic name specified in the TO block. At block 1055, the Channel Write routine is called with the data buffer and the obtained channel number and socket. The run phase ends at block 1060.

FIG. 10C shows the termination phase 1070 (mdlTerminate) routine of the TO block under Simulink. The termination phase starts at block 1075. At block 1080, the terminate network routine shown in FIG. 11B and described above in connection with FIG. 9C is run, and the termination phase ends at block 1085.

FIG. 12 illustrates a simplified exemplary process for executing a Simulink simulation 1200 on a single device to aid in understanding the operations of the TO and FROM blocks when using a channel connection in accordance with embodiments of the present invention as described above in FIGS. 9-11. The simulation starts at block 1210. At block 1220, the initialization phase is executed, and the mdlStart routine is run for each block in the Simulink block diagram software application. At block 1230, all of the blocks are executed in a predetermined order by running the mdlOutput routine for each block. At block 1240, a determination is made whether the simulation is complete. If not, all of the blocks are again executed in the predetermined order by running the mdlOutput routine for each block. If so, the termination phase is executed, and mdlTerminate is run for each block at block 1250. The simulation ends at block 1260.

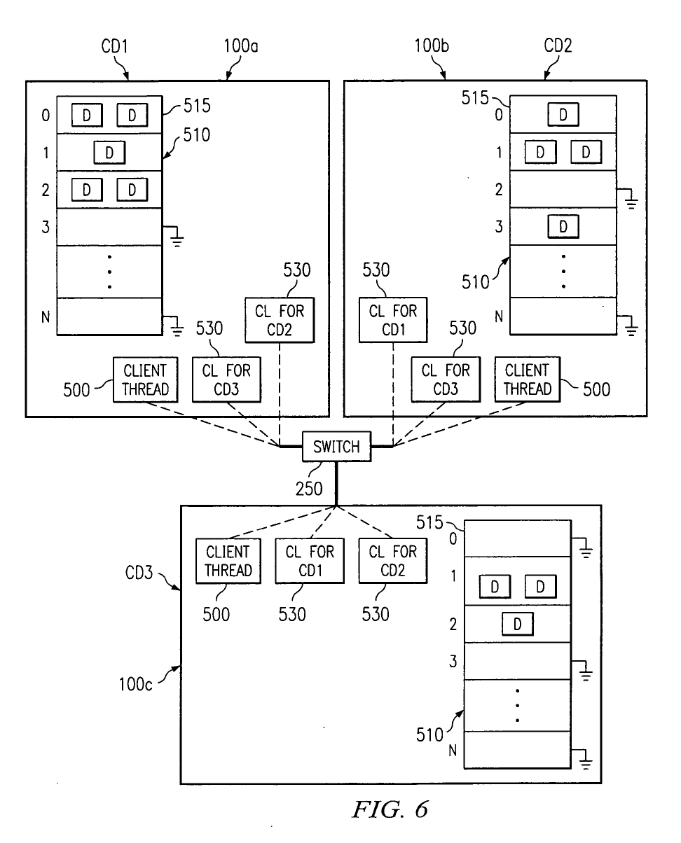

As shown in FIG. 6, a block diagram software application can be run on multiple computing devices 100a-c with multiple queue channels 515 connecting the different blocks of the block diagram software application running on the different computing devices 100a-c. A network computing environment is shown in FIG. 6, in which a switch 250 interconnects the computing devices 100a-c (CD1, CD2, CD3) and switches service requests and data therebetween. However, it should be understood that the multiple block/multiple computer embodiment of the present invention can be implemented on any type of computing environment.

Each computing device 100a-c (CD1, CD2, CD3) has a channel queue array 510 including one or more queue channels 515 for enqueueing data associated with a block diagram software application. A client thread 500 on each computing device 100a-c waits for service requests from the other computing devices 100a-c and creates slave client listener threads 530 for each service request received. For example, the client thread 530 on computing device CD1 100a creates a slave client listener thread 530 for a service request received from computing device CD2 100b and a slave client listener thread 530 for a service request received from computing device CD3 100c. Each client listener thread 530 is capable of accessing the channel queue array 510 simultaneously, assuming there are resource conflicts, to enqueue received data on the appropriate specified queue channel(s) 515 associated with the block diagram software application.

Turning now to FIGS. 7A and 7B, exemplary overviews of the channel connection at the sending computing device and the receiving computing device are shown, in accordance with embodiments of the present invention. FIGS. 7A and 7B illustrate an exemplary implementation of the channel connection in Simulink. However, it should be understood that other implementations of the channel connection in other block diagram software applications are possible.

As discussed above in connection with FIG. 4B, two blocks 400 and 450 of a block diagram software application can be split and stored on separate computing devices 100a and 100b by using a channel connection to link the first block 400 on the first computing device 100a to the second block 450 on the second computing device 100b. The channel connection includes a TO block 410 on the sending computing device 100a and a FROM block 430 on the receiving computing device 100b.

As shown in FIG. 7A, the TO block 410 on the sending computing device 100a receives data 420 from the first block 400 and stores the data 420 in a data buffer 760. The TO block 410 further calls the Channel Write routine 550 to read the data 420 out of the data buffer 760 and transmit the data 420 to the receiving computing device (100b, shown in FIG. 7B). The TO block 410 is provided with a symbolic name 710 identifying the connection between the first and second blocks 400 and 450. The TO block 410 accesses a look-up table 700 to retrieve the channel identifier, including the target computing device name 720 (node ID), socket 730 and channel number(s) 520 matching the symbolic name 710, and passes the node ID 720, socket 730 and channel number(s) 520 to the Channel Write routine 550.

In other embodiments, the TO block 410 can be programmed with the node ID 720, socket 730 and channel number(s) 520 directly. However, by using a look-up table 700 (referred to as NameMap in connection with FIGS. 9B, 10B, 11A and 11B), the node ID 720, socket 730 and channel number(s) 520 can be easily modified without re-programming the TO block 410. To reduce the number of look-ups in frequently accessed block diagram software applications, the node ID 720, socket 730 and channel number(s) 520 can be stored by the TO block 410. It should be understood that other mechanisms of dynamically linking between the channel connection and channel identifier can be used, instead of the look-up table 700 described herein.

As shown in FIG. 7B, the FROM block 430 on the receiving computing device 100b receives the data 420 sent by the computing device (100a, shown in FIG. 7A) and enqueued on the specified queue channel 515 in the channel queue array 510 by a client listener thread 530. The FROM block 430 calls the Channel Read routine 560 to read the data 420 out of the queue channel 515 and provide the data 420 to the second block 450 of the block diagram software application. If there is no data stored in the channel queue array 510 when the FROM block 430 calls the Channel Read routine 560, the FROM block 430 enters a wait mode until the FROM block 430 calls the Channel Read routine 560 again.

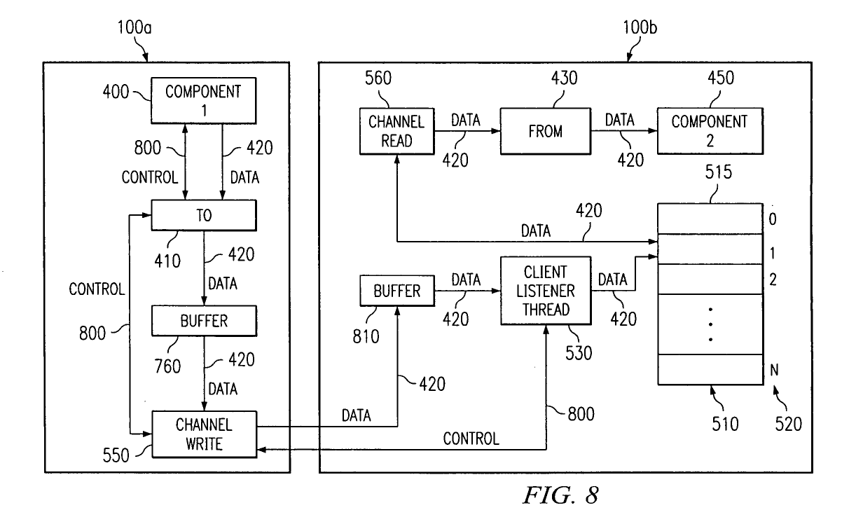

FIG. 8 illustrates exemplary functionality for providing data flow control between the sending and receiving computing devices 100a and 100b, respectively, in accordance with embodiments of the present invention. FIG. 8 also illustrates exemplary functionality in Simulink. However, it should be understood that other functionality in other block diagram software applications are possible. As described above in connection with FIGS. 7A and 7B, the TO block 410 on the sending computing device 100a receives data 420 from the first block 400 and stores the data 420 in a sending data buffer 760. The TO block 410 further calls the Channel Write routine 550 to read the data 420 out of the sending data buffer 760 and transmit the data 420 to the receiving computing device 100b. At the receiving computing device 100b, the client listener thread 530 stores the data 420 in a receiving data buffer 810 before enqueuing the data 420 on the specified queue channel 515 in the channel queue array 510. The FROM block 430 calls the Channel Read routine 560 to read the data 420 out of the queue channel 515 and transmit the data 420 to the second block 450 of the block diagram software application.

To control the flow of data 420 between the sending computing device 100a and the receiving computing device 100b, control (or signaling) information 800 is passed within and between the sending computing device 100a and the receiving computing device 100b. Control information 800 is sent between the sending computing device 100a and the receiving computing device 100b to manage data flow between the computing devices 100a and 100b. For example, the first computing device 100a can send control information 800 to the receiving computing device 100b indicating that additional data 420 is waiting in the sending data buffer 760. As another example, the receiving computing device 100b can send control information 800 to the sending computing device 100a indicating that the receiving queue channel 515 is full and that it is necessary to wait until there is storage available in the receiving queue channel 515.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

1. A distributed computing system, comprising:
a first computing device configured to execute a first block of a block diagram software application to produce an output; and
means for transparently communicating with a second computing device to provide the output of the first block to a second block of the block diagram software application resident on the second computing device.

2. The computing system of claim 1, wherein said first computing device comprises:
a storage device having computer-executable instructions stored therein, said computer-executable instructions for executing the first block of the block diagram software application; and
a processor connected to run said computer-executable instructions and communicate with the second computing device.

3. The computing system of claim 1, wherein said means for transparently communicating comprises a communications protocol using a channel Application Programming Interface (API).

4. The computing system of claim 2, wherein the channel API is capable of establishing a connection between said first computing device and the second computing device using a channel representing a logical connection between said first computing device and the second computing device and transmitting data therebetween over the channel.

5. The computing system of claim 1, further comprising:
a table within said first computing device including a channel identifier of a queue channel dynamically linking said first computing device and the second computing device, an identity of the second computing device and a symbolic name associated with said channel identifier, said first computing device being configured to have access to the symbolic name and use the symbolic name to dynamically link to said table and determine said channel identifier.

6. The computing system of claim 5, further comprising:
a channel connection of the block diagram software application, said first computing device being further configured to execute a first portion of said channel connection to determine said channel identifier and communicate with the second computing device.

7. The computing system of claim 6, wherein the second computing device is configured to execute a second portion of said channel connection, the second portion of said channel connection providing the output to the second block of the block diagram software application to enable execution of the second block of the block diagram software application on the second computing device.

8. The computing system of claim 7, wherein the first portion of said channel connection is configured to receive data from the first block of the block diagram software application and transmit the data to the second portion of said channel connection, and the second portion of said channel connection is configured to queue the data on the queue channel and read the data from the queue channel to provide the data to the second block of the block diagram software application.

9. The computing system of claim 8, wherein the second computing device further comprises:
a channel queue array including the queue channel, said channel identifier being an address of the queue channel within said channel queue array.

10. The computing system of claim 9, wherein the second computing device further comprises:
a thread configured to receive a service request from said first computing device and establish a connection with said first computing device; and
a slave thread created by said thread and configured to receive the data from said first computing device and queue the data on the queue channel.

11. The computing system of claim 1, wherein said first computing device and the second computing device are further configured to control the flow of data therebetween.

12. The computing system of claim 9, further comprising:
control information sent by and between said first computing device and the second computing device to control the flow of data within and between said first computing device and the second computing device.

13. A method for executing a block diagram software application distributed across multiple computing devices, comprising:
executing a first block of the block diagram software application on a first computing device to produce an output;
transparently communicating with a second computing device to provide the output to a second block of the block diagram software application; and
executing the second block on the second computing device.

14. The method of claim 13, wherein said transparently communicating is performed by a communications protocol using a channel Application Programming Interface (API).

15. The method of claim 14, wherein said transparently communicating further comprises:
establishing a connection between said first computing device and the second computing device using a channel representing a logical connection between said first computing device and the second computing device; and
transmitting data between said first computing device and the second computing device over the channel.

16. The method of claim 13, wherein said transparently communicating further comprises:
storing within a table a channel identifier of a queue channel dynamically linking said first computing device and the second computing device, an identity of the second computing device and a symbolic name associated with the channel identifier; and
accessing said table using said symbolic name to determine the channel identifier.

17. The method of claim 16, wherein said transparently communicating further comprises:
executing a first portion of a channel connection on the first computing device to determine the queue channel; and
executing a second portion of the channel connection on the second computing device to enable execution of the second block of the block diagram software application.

18. The method of claim 17, wherein said executing the first portion of the channel connection further comprises:
receiving data from the first block of the block diagram software application; and
transmitting the data to the second portion of said channel connection.

19. The method of claim 18, wherein said executing the second portion of the channel connection further comprises:
queueing the data on the queue channel; and
reading the data from the queue channel to provide the data to the second block of the block diagram software application.

20. The method of claim 19, wherein said queueing further comprises:
queueing the data on the queue channel within a channel queue array on the second computing device, the channel identifier being an address of the queue channel within the channel queue array.

21. The method of claim 20, wherein said executing the second portion of the channel connection further comprises:
creating a thread to receive a service request from the first computing device to establish a connection with the first computing device; and
creating a slave thread to receive the data from the first computing device and queue the data on the queue channel.

22. The method of claim 21, wherein said executing the second portion of the channel connection further comprises:
using the slave thread to receive additional data from the first computing device and queue the additional data on the queue channel, the additional data being produced from the first block of the block diagram software application.

23. The method of claim 15, further comprising:
controlling the flow of data between the first and second computing devices.

24. The method of claim 23, wherein said controlling further comprises:
transmitting control information by and between the first and second computing devices to control the flow of data within and between the first and second computing devices.
